(19) United States
(12) Patent Application Publication
(10) Pub. No.: US 2012/0182652 A1
(43) Pub. Date: Jul. 19, 2012

(54) ESD PROTECTION STRUCTURE

(75) Inventor: Kuang-Yu Jung, Taipei City (TW)

(73) Assignee: BEYOND INNOVATION TECHNOLOGY CO., LTD., TAIPEI CITY (TW)

(21) Appl. No.: 13/104,031

(22) Filed: May 10, 2011

(30) Foreign Application Priority Data
Aug. 19, 2010 (TW) 99127789

(51) Int. Cl. H02H 9/04

(52) U.S. Cl. 361/56

(57) ABSTRACT

An electrostatic discharge (ESD) protection structure is provided, which includes a bonding pad, a body, an insulation layer, a first doped region and a via. The body is a first conductive type, while the first doped region is a second conductive type. The bonding pad is disposed on the body. The insulation layer is disposed between the body and the bonding pad. The first doped region is disposed in the body, and in view direction along the vertical projection of the body, all of the bonding pad is disposed in the first doped region. The via is disposed between the first doped region and the bonding pad. The bonding pad is electrically connected to the first doped region through the via.

### CROSS-REFERENCE TO RELATED APPLICATION

This application claims the priority benefit of Taiwan application serial no. 99127789, filed Aug. 19, 2010. The entirety of the above-mentioned patent application is hereby incorporated by reference herein and made a part of this specification.

### BACKGROUND OF THE INVENTION

1. Field of the Invention

The invention generally relates to a layout structure of an integrated circuit (IC), and more particularly, to a layout structure of an electrostatic discharge (ESD) protection circuit under a bonding pad.

2. Description of Related Art

In a real application environment, ESD come from various sources would shock an electronic product. When ESD occurs, the sudden ESD current may burn a component instantaneously. In order to overcome the above-mentioned problem, usually some ESD mechanisms are designed and placed in the circuit so as to effectively guide the ESD current out to avoid the component from being burned.

FIG. 1 is a diagram illustrating a traditional IC 100 equipped with two ESD protection components 112 and 113. For the IC 100, the two ESD protection components 112 and 113 would be disposed nearby a bonding pad 111 so as to protect a core circuit 130. When ESD occurs at the bonding pad 111, the ESD current would be guided to a power line VDD through the ESD protection component 112 (and/or guided to another power line VSS through the ESD protection component 113) so as to avoid the core circuit 130 from being burned. Meantime, a resistor 120 can provide a sufficient impedance to prevent abundant ESD current flowing into the core circuit 130.

FIG. 2 is a cross-sectional diagram of the traditional layout structure of the ESD protection components 112 and 113 and the bonding pad 111 in FIG. 1. The bonding pad 111 is disposed over an IC substrate 210 and the ESD protection components 112 and 113 are disposed in the IC substrate 210. During a wire bonding process, the bonding pad 111 suffers a very large vertical stress, and the vertical stress may make the bonding pad 111 deformed or sunk, even break the insulation layer between the bonding pad 111 and the IC substrate 210 down. As a result, no component, circuit, wire or doped region is allowed to be disposed under the bonding pad 111 for the traditional layout structure so as to avoid mistakably electrical-connecting to the bonding pad 111. Sometimes, when the vertical stress during wire bounding is too large, the stress even makes the bonding pad 111 electrically contact the IC substrate 210 and leads to a low production yield.

### SUMMARY OF THE INVENTION

Accordingly, the invention is directed to an ESD protection structure capable of enhancing the ESD protection ability, reducing the area of an ESD protection circuit and even increasing the production yield.

The invention provides an ESD protection structure which includes a body, an insulation layer, a bonding pad, a first doped region and a via. The body is a first conductive type, while the first doped region is a second conductive type. The bonding pad is disposed on the body. The insulation layer is disposed between the body and the bonding pad. The first doped region is disposed in the body, and in view direction along the vertical projection of the body, all of the bonding pad is disposed in the first doped region. The via is disposed between the first doped region and the bonding pad and goes through the insulation layer. The bonding pad is electrically connected to the first doped region through the via.

In an embodiment of the present invention, the above-mentioned ESD protection structure further includes a second doped region. The second doped region is the first conductive type and disposed in the body but outside the first doped region. The second doped region is electrically connected to a first power line.

Based on the mentioned above, a parasitic diode (i.e., the ESD protection component) is formed at a PN junction between the first doped region and the body. The present invention utilizes the space under the bonding pad and disposes the first doped region electrically connected to the bonding pad so that the area of the ESD protection circuit is reduced. Since the electrical path distance between the bonding pad and the ESD protection component is largely reduced, the ESD protection ability can be advanced. Moreover, even though the bonding pad contacts the first doped region of the IC substrate when the vertical stress is too large during wire bonding, the function of the IC still is not affected and the production yield can be increased.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a traditional IC circuit equipped with ESD protection components.

FIG. 2 is a cross-sectional diagram of the traditional layout structure of the ESD protection components and the bonding pad in FIG. 1.

FIG. 3 is a top view diagram of a layout structure of the ESD protection components and the bonding pad in FIG. 1 according to an embodiment of the invention.

FIG. 4 is a cross-sectional diagram of the ESD protection structure in FIG. 3 along A-A′ line according to another embodiment of the invention.

FIG. 5 is an equivalent circuit diagram of an ESD protection structure where a bonding pad is used to serve as a power pad according to another embodiment of the invention.

FIG. 6 is a top view diagram of the layout structure of the ESD protection components and the bonding pad in FIG. 1 according to yet another embodiment of the invention.

FIG. 7 is a cross-sectional diagram of the ESD protection structure in FIG. 6 along B-B′ line according to the embodiment of the invention.

FIG. 8 is an equivalent circuit diagram of an ESD protection structure where a bonding pad is used to serve as a power pad according to yet another embodiment of the invention.

FIG. 9 is a cross-sectional diagram of an ESD protection structure according to yet another embodiment of the invention.

### DESCRIPTION OF THE EMBODIMENTS

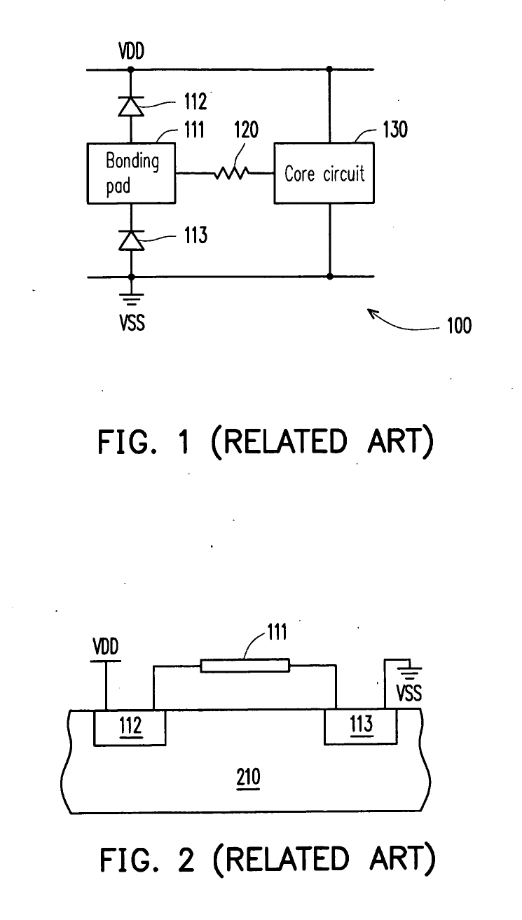

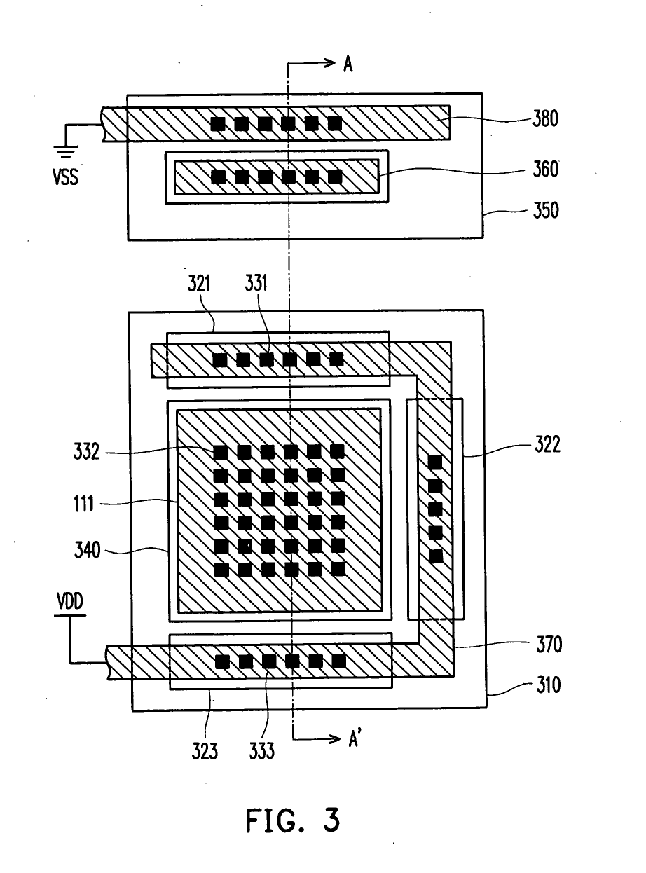

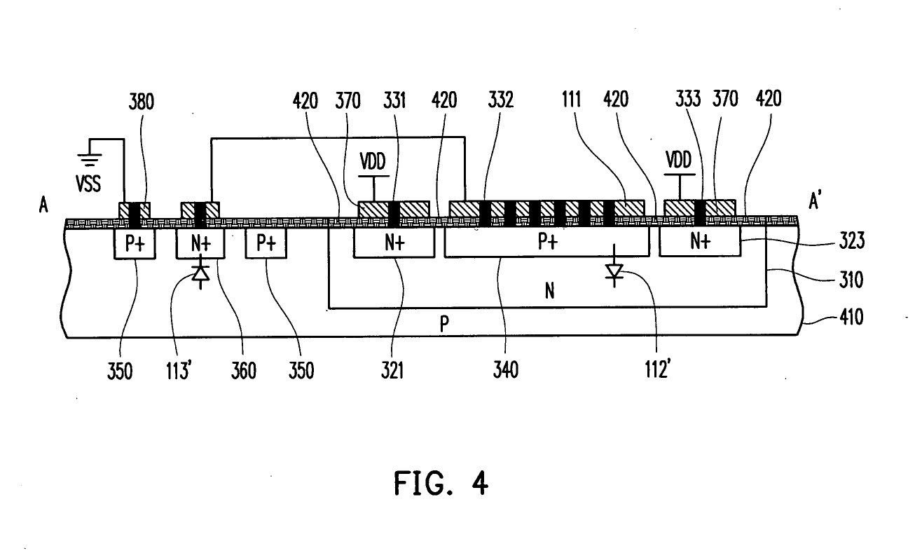

FIG. 3 is a top view diagram of a layout structure equivalent to that of the ESD protection components 112 and 113 and the bonding pad 111 in FIG. 1 in the prior art according to an embodiment of the invention. FIG. 4 is a cross-sectional diagram of the ESD protection structure in FIG. 3 along A-A′ line according to another embodiment of the invention. Referring to FIGS. 3 and 4, a body (or buck) 310 is a first conductive type, wherein the first conductive type is assumed to be N-doped conductive type, and the body 310 is an N-well disposed in an IC substrate 410. The IC substrate 410 is a second conductive type, wherein the second conductive type is assumed to be P-doped conductive type.

A first doped region 340 herein is a P-type heavy doped region (P+ area). The first doped region 340 is disposed in the body 310 so that a parasitic diode 112′ is formed at the PN junction between the first doped region 340 and the body 310, and the parasitic diode 112′ can be equivalent to the ESD protection component 112 shown in FIG. 1.

A bonding pad 111 is disposed on the body 310, and in view direction along the vertical projection of the body 310, all of the bonding pad 111 is disposed in the first doped region 340. An insulation layer 420 is disposed between the body 310 and the bonding pad 111. A plurality of vias 332 are disposed between the first doped region 340 and the bonding pad 111 and go through the insulation layer 420. The bonding pad 111 is electrically connected to the first doped region 340 through the vias 332. It should be noted that the insulation layer 420 shown by the embodiment is a schematic sketch merely; in some embodiments, the insulation layer 420 can represent a single insulation layer, while in other embodiments, the insulation layer 420 represents a plurality of conductive layers and a plurality of insulation layers between the body 310 and the bonding pad 111.

A plurality of second doped regions 321, 322 and 323 are N-type heavy doped regions (N+ areas) and disposed in the body 310 but outside the first doped region 340. The second doped regions 321, 322 and 323 are electrically connected to a first power line VDD through the vias (for example, 331 and 333) and a conductive line 370. The second doped regions 321, 322 and 323 surround the first doped region 340. In specific, the second doped regions 321, 322 and 323 shown by the embodiment are an exemplary implementation only; in other embodiments, the second doped regions 321, 322 and 323 can be a single N+ area in U-shape surrounding the first doped region 340, or the second doped regions 321, 322 and 323 can be a single N+ area in ring-shape surrounding the first doped region 340.

When an ESD event occurs at the bonding pad 111, the positive pulse ESD current can be guided to the first power line VDD through the vias 332, the first doped region 340, the body 310, the second doped regions 321-323 and the conductive line 370.

A third doped region 360 is an N+ area and disposed in the IC substrate 410 but outside the body 310, so that a parasitic diode 113′ is formed at the PN junction between the third doped region 360 and the IC substrate 410, and the parasitic diode 113′ can be equivalent to the ESD protection component 113 shown in FIG. 1. The third doped region 360 is electrically connected to the bonding pad 111 through the vias and the conductive line.

A fourth doped region 350 is a P+ area and disposed in the IC substrate 410 but outside the body 310 and the third doped region 360. In the embodiment, the fourth doped region 350 in ring-shape surrounds the third doped region 360. The fourth doped region 350 is electrically connected to a second power line VSS through the vias and the conductive line 380.

When an ESD event occurs at the bonding pad 111, the negative pulse ESD voltage can drain the ESD current from the second power line VSS, the conductive line 380, the fourth doped region 350, the IC substrate 410 and the third doped region 360.

The above-mentioned instruction of the embodiment can be modified by the embodiment user according to the design requirement. For example, if the above-mentioned IC substrate 410 needs to be implemented by an N-type IC substrate, consequently, the body 310 can be a P-well, the first doped region 340 and the fourth doped region 350 can be N+ areas, and the second doped regions 321-323 and the third doped region 360 can be P+ areas. In the embodiment, the second doped regions 321, 322 and 323 are electrically connected to the power line VSS through the vias (for example, 331 and 333) and the conductive line 370, and the fourth doped region 350 is electrically connected to the power line VDD through the vias and the conductive line 380. When a positive pulse ESD event occurs at the bonding pad 111, the ESD current can be guided to the power line VDD through the third doped region 360, the IC substrate 410, the fourth doped region 350 and the conductive line 380. When a negative pulse ESD event occurs at the bonding pad 111, the ESD current can be guided to the power line VSS from the vias 332, the first doped region 340, the body 310, the second doped regions 321-323 and the conductive line 370.

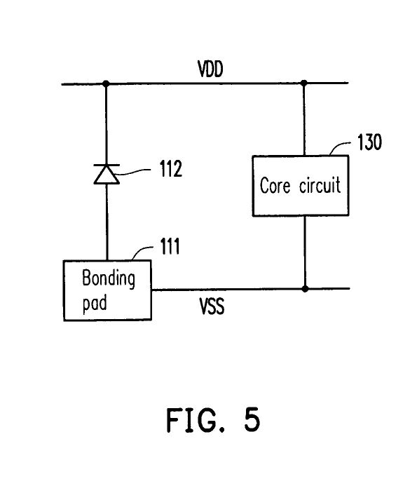

If the bonding pad 111 serves as the power pad of an IC, the conductive line 380, the fourth doped region 350 and the third doped region 360 in FIGS. 3 and 4 can be omitted. Under the application example, the bonding pad 111 in FIGS. 3 and 4 is electrically connected to the second power line VSS in the IC. FIG. 5 is an equivalent circuit diagram of an ESD protection structure where a bonding pad 111 is used to serve as a power pad according to another embodiment of the invention. Referring to FIGS. 4 and 5, when the bonding pad 111 is electrically connected to the second power line VSS and the conductive line 380, the fourth doped region 350 and the third doped region 360 are omitted, the PN junction between the first doped region 340 and the body 310 can be equivalent to the ESD protection component 112 between the first power line VDD and the second power line VSS shown in FIG. 5.

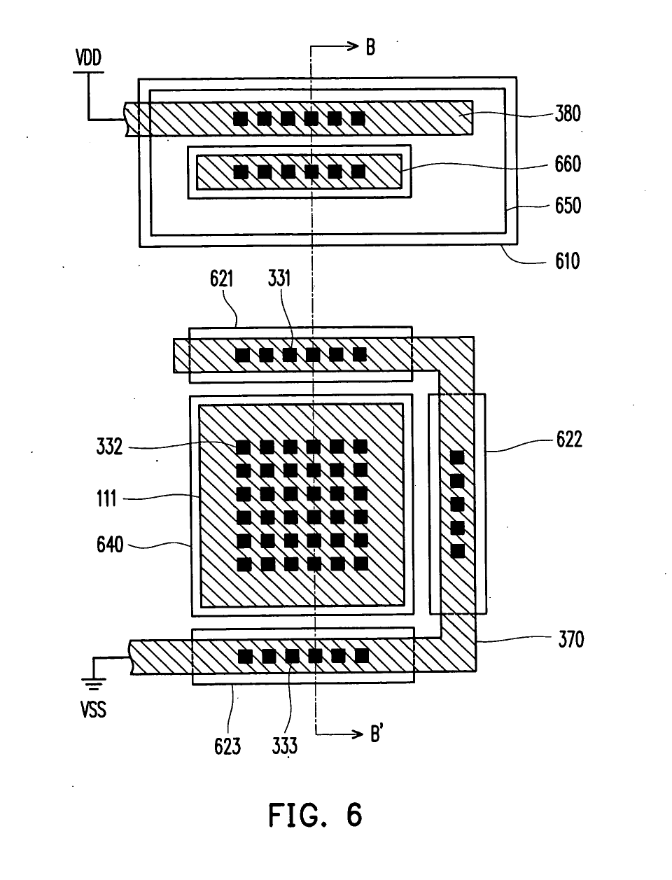

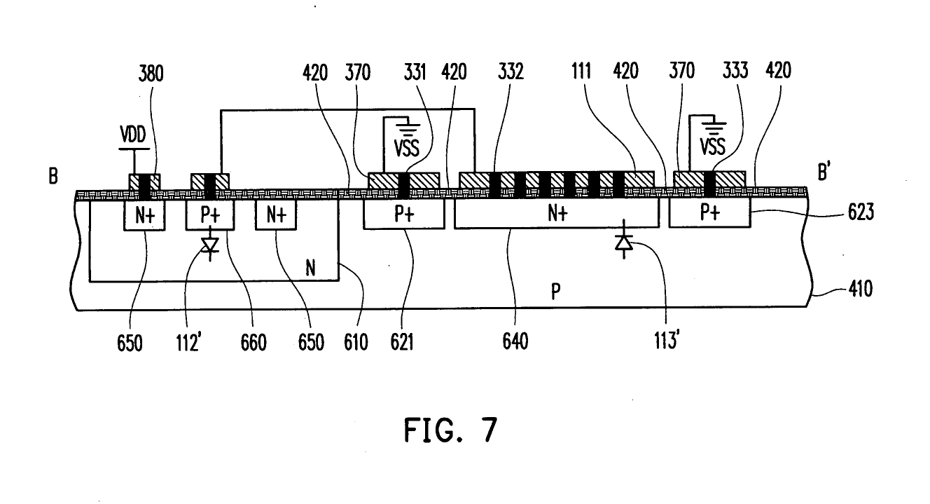

FIG. 6 is a top view diagram of the layout structure of the ESD protection components 112 and 113 and the bonding pad 111 in FIG. 1 according to yet another embodiment of the invention and FIG. 7 is a cross-sectional diagram of the ESD protection structure in FIG. 6 along B-B′ line according to the embodiment of the invention. The most details in FIGS. 6 and 7 can be referred to FIGS. 3 and 4 except that in the embodiment of FIGS. 6 and 7, the first conductive type is P-doped conductive type while the second conductive type is N-doped conductive type. In addition, the first power line and the second power line in the embodiment of FIGS. 3 and 4 are respectively the power line VDD and the power line VSS, while the first power line and the second power line in the embodiment of FIGS. 6 and 7 are respectively the power line VSS and the power line VDD.

Referring to FIGS. 6 and 7, the body of the parasitic diode 113′ is the P-type IC substrate 410 and the body of the parasitic diode 112′ is the N-well 610 disposed in the IC substrate 410.

The first doped region 640 is an N-type heavy doped region (N+ area) and disposed in the IC substrate 410, so that a parasitic diode 113′ is formed at the PN junction between the first doped region 640 and the IC substrate 410, and the parasitic diode 113′ can be equivalent to the ESD protection component 113 shown in FIG. 1

In view direction along the vertical projection of the IC substrate 410, all of the bonding pad 111 is disposed in the first doped region 640. The bonding pad 111 is electrically connected to the first doped region 640 through the vias 332. A plurality of second doped regions 621, 622 and 623 are P-type heavy doped regions (P+ areas) and disposed in the IC substrate 410 but outside the first doped region 640. The second doped regions 621, 622 and 623 are electrically connected to a first power line VSS through the vias (for example, 331 and 333) and the conductive line 370. The second doped regions 621, 622 and 623 surround the first doped region 640. In other embodiments, the second doped regions 621, 622 and 623 can be a single P+ area in U-shape surrounding the first doped region 640, or the second doped regions 621, 622 and 623 can be a single P+ area in ring-shape surrounding the first doped region 640.

The N-well 610 is disposed in the IC substrate 410 but outside the first doped region 640. A third doped region 660 is a P+ area and disposed in the N-well 610 so that another parasitic diode 112′ is formed at the PN junction between the third doped region 660 and the N-well 610, and the parasitic diode 112′ can be equivalent to the ESD protection component 112 shown in FIG. 1. The third doped region 660 is electrically connected to the bonding pad 111. A fourth doped region 650 is an N+ area and disposed in the N-well 610 but outside the third doped region 660. In the embodiment, the fourth doped region 650 in ring-shape surrounds the third doped region 660. The fourth doped region 650 is electrically connected to a second power line VDD through the conductive line 380.

When a positive pulse ESD event occurs at the bonding pad 111, the ESD current can be guided to the first power line VDD through the third doped region 660, the N-well 610, the fourth doped region 650 and the conductive line 380. When a negative pulse ESD occurs at the bonding pad 111, the ESD current can be guided to the first power line VSS through the vias 332, the first doped region 640, the IC substrate 410, the second doped regions 621-623 and the conductive line 370.

The above-mentioned instruction of the embodiment in FIGS. 6 and 7 can be modified by the embodiment user according to the design requirement. For example, if the above-mentioned IC substrate 410 in FIGS. 6 and 7 needs to be implemented by an N-type IC substrate, consequently, the well 610 can be a P-well, the first doped region 640 and the fourth doped region 650 can be P+ areas, and the second doped regions 621-623 and the third doped region 660 can be N+ areas. In the embodiment, the second doped regions 621-623 are electrically connected to the power line VDD through the vias (for example, 331 and 333) and the conductive line 370, and the fourth doped region 650 is electrically connected to the power line VSS through the vias and the conductive line 380. When a positive pulse ESD event occurs at the bonding pad 111, the ESD current can be guided to the power line VDD through the vias 332, the first doped region 640, the IC substrate 410, the second doped regions 621-623 and the conductive line 370. When a negative pulse ESD event occurs at the bonding pad 111, the ESD current can be guided to the power line VSS from the third doped region 660, the well 610, the fourth doped region 650 and the conductive line 380.

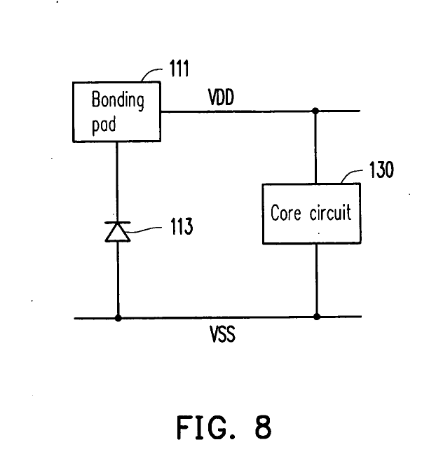

If the bonding pad 111 serves as the power pad of an IC, the conductive line 380, the N-well 610, the fourth doped region 650 and the third doped region 660 in FIGS. 6 and 7 can be omitted. Under the application example, the bonding pad 111 in FIGS. 6 and 7 is electrically connected to the second power line VDD in the IC. FIG. 8 is an equivalent circuit diagram of an ESD protection structure where a bonding pad 111 is used to serve as a power pad according to another embodiment of the invention. Referring to FIGS. 7 and 8, when the bonding pad 111 is electrically connected to the second power line VDD and the conductive line 380, the N-well 610, the fourth doped region 650 and the third doped region 660 are omitted, and the PN junction between the first doped region 640 and the IC substrate 410 can be equivalent to the ESD protection component 113 between the power line VDD and the power line VSS shown in FIG. 8.

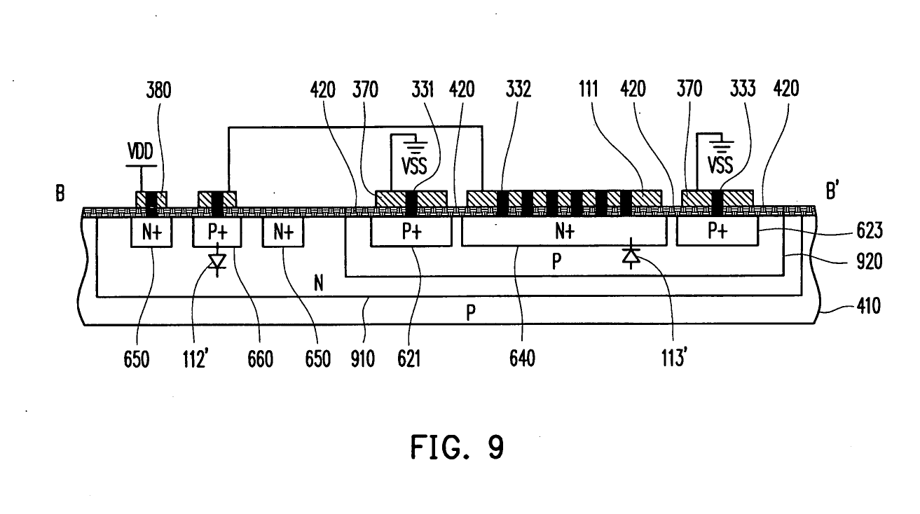

FIG. 9 is a cross-sectional diagram of an ESD protection structure according to yet another embodiment of the invention. The most details in FIG. 9 can be referred to FIG. 7 except that the embodiment of FIG. 9 includes a deep-well 910 and a body 920. The deep-well 910 is a deep-N-well and the body 920 is a P-well. The deep-well 910 is disposed in the IC substrate 410 and the body 920 is disposed in the deep-well 910.

Referring to FIG. 9, the first doped region 640 and the second doped regions 621, 622 and 623 are disposed in the body 920, so that a parasitic diode 113′ is formed at the PN junction between the first doped region 640 and the body 920, and the parasitic diode 113′ can be equivalent to the ESD protection component 113 shown in FIG. 1. The third doped region 660 and the fourth doped region 650 are disposed in the deep-well 910 but outside the body 920, so that another parasitic diode 112′ is formed at the PN junction between the third doped region 660 and the deep-well 910, and the parasitic diode 112′ can be equivalent to the ESD protection component 112 shown in FIG. 1.

The above-mentioned instruction of the embodiment in FIG. 9 can be modified by the embodiment user according to the design requirement. For example, if the above-mentioned IC substrate 410 in FIG. 9 needs to be implemented by an N-type IC substrate, consequently, the deep-well 910 can be a deep P-well, the body 920 can be an N-well, the first doped region 640 and the fourth doped region 650 can be P+ areas and the second doped regions 621-623 and the third doped region 660 can be N+ areas. In the embodiment, the second doped regions 621-623 are electrically connected to the power line VDD through the vias (for example, 331 and 333) and the conductive line 370, and the fourth doped region 650 is electrically connected to the power line VSS through the vias and the conductive line 380. When a positive pulse ESD event occurs at the bonding pad 111, the ESD current can be guided to the power line VDD through the vias 332, the first doped region 640, the body 920, the second doped regions 621-623 and the conductive line 370. When a negative pulse ESD event occurs at the bonding pad 111, the ESD current can be guided to the power line VSS from the third doped region 660, the deep-well 910, the fourth doped region 650 and the conductive line 380.

In summary, the above-mentioned embodiments utilize the space under the bonding pad 111, dispose the first doped region 340 (or 640) electrically connected to the bonding pad 111 and use the PN junction between the first doped region 340 (or 640) and the body 310 (or the substrate 410 or the body 920) to form an ESE) protection component so as to reduce the area of the ESD protection circuit. Since the first doped region 340 (or 640) is disposed under the bonding pad 111, so that the electrical path distance between the bonding pad 111 and the ESD protection component is largely reduced, which further advances the ESD protection ability. Moreover, even though the bonding pad 111 contacts the first doped region 340 (or 640) of the IC substrate 410 when the vertical stress of the bonding pad 111 is too large during wire bonding, the function of the IC still is not affected and the production yield can be increased.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An electrostatic discharge protection structure, comprising:
a body, being a first conductive type;
a bonding pad, disposed on the body;
an insulation layer, disposed between the body and the bonding pad;
a first doped region, being a second conductive type and disposed in the body, wherein in view direction along the vertical projection of the body, all of the bonding pad is disposed in the first doped region; and
a via, disposed between the first doped region and the bonding pad and going through the insulation layer, wherein the bonding pad is electrically connected to the first doped region through the via.

2. The electrostatic discharge protection structure as claimed in claim 1, wherein when the second conductive type is P-type, the first conductive type is N-type.

3. The electrostatic discharge protection structure as claimed in claim 1, wherein when the second conductive type is N-type, the first conductive type is P-type.

4. The electrostatic discharge protection structure as claimed in claim 1, further comprising a second doped region being a first conductive type and disposed in the body but outside the first doped region, wherein the second doped regions is electrically connected to a first power line.

5. The electrostatic discharge protection structure as claimed in claim 1, wherein the body is an integrated circuit substrate.

6. The electrostatic discharge protection structure as claimed in claim 5, further comprising:
a first well, being a second conductive type and disposed in the body but outside the first doped region;
a third doped region, being a first conductive type and disposed in the first well, wherein the third doped region is electrically connected to the bonding pad; and
a fourth doped region, being a second conductive type and disposed in the first well but outside the third doped region, wherein the fourth doped region is electrically connected to a second power line.

7. The electrostatic discharge protection structure as claimed in claim 1, wherein the body is a well disposed in an integrated circuit substrate and the integrated circuit substrate is the second conductive type.

8. The electrostatic discharge protection structure as claimed in claim 7, further comprising:
a third doped region, being a first conductive type and disposed in the integrated circuit substrate but outside the body, wherein the third doped region is electrically connected to the bonding pad; and
a fourth doped region, being a second conductive type and disposed in the integrated circuit substrate but outside the body and the third doped region, wherein the fourth doped region is electrically connected to a second power line.

9. The electrostatic discharge protection structure as claimed in claim 1, further comprising:
a deep-well, being a second conductive type and disposed in an integrated circuit substrate;
wherein the body is disposed in the deep-well.
